(19) United States
(12) Patent Application Publication
(10) Pub. No.: US 2003/0033879 A1
(43) Pub. Date: Feb. 20, 2003

(54) Blockage detection method and associated system

(76) Inventors: Michael A. Adewumi, Lemont, PA (US); Daniel B. Lysak, State College, PA (US); Sarafa O. Ibraheem, Piscataway, NJ (US)

Correspondence Address: William F. Lang, IV, Eckert Seamans Cherin & Mellott, LLC, 44th Floor, 600 Grant Street, Pittsburgh, PA, 15219, US

(21) Appl. No.: 09/925,860

(22) Filed: Aug. 9, 2001

(51) Int. Cl. G01N 29/00

(52) U.S. Cl. 73/627

(57) ABSTRACT

A method of detecting the presence or absence of a blockage in an enclosed environment is provided. The method includes introducing an acoustic wave into the enclosed environment; receiving at sensor locations the acoustic wave and any reflected acoustic wave caused by the acoustic wave contacting a blockage; and, analyzing the acoustic wave and any reflected acoustic wave to determine the presence or absence of the blockage. The method can also include coherently accumulating into a digitized data array an electrical response indicative of the received acoustic wave and any reflected acoustic wave caused by the blockage. The method can further include computing a correlation between the introduced acoustic wave and the digitized data array. A system is also disclosed for detecting the presence or absence of a blockage in an enclosed environment. The system can include a communications interface for remote analysis and/or control of the system by a user. In another aspect, a computer-readable medium is provided that contains instructions for controlling a computer to perform detection and analysis on blockages in an enclosed environment. The instructions comprise constructing an interrogation waveform at a predetermined sampling rate; directing a transmitter to introduce an interrogation acoustic wave into the enclosed environment; coherently accumulating an electrical response into a digitized array representative of the interrogation acoustic waves and the acoustic waves reflected from a blockage; and, computing a correlation between said interrogation acoustic wave and said digitized data array.

### BACKGROUND OF THE INVENTION

1. Field of the Invention

This invention generally relates to a blockage detection method and associated system, and more particularly to detecting the presence or absence of a blockage in an enclosed environment.

2. Description of Related Art

In the operation of pipelines such as gas transmission lines, there exists the potential for blockage of the normal pipeline flow by condensed or deposited matter. The physical composition of the blockage can vary and can include gas hydrates, heavy hydrocarbons such as paraffins and waxes, and sand, among other types of matter. A blocked pipeline can cause substantial loss of revenue to a business relying on the continuous flow of the contents of the pipeline. Addressing pipeline blockages is generally expensive due to the relatively high cost of the equipment, machinery and other resources needed to reduce or eliminate blockages. In the case of severe blockages, it can be necessary to abandon the pipeline altogether. In addition, the safety hazards associated with maintenance and repair of a pipeline are particularly magnified when the pipeline is located in a hostile environment such as in the case of deep-water applications.

A key difficulty in identifying and addressing a pipeline blockage is that the location of the blockage cannot always be determined with accuracy and precision. Also, with specific regard to applications associated with deep-water production, localized detection and treatment of blockages can be at best impractical and at worst impossible. In the gas industry, data pertaining to a single-phase gas flow, such as the velocity and pressure of the flow in a given portion of a pipe, is of substantial value. A detection system and its associated methods that are capable of remotely determining the location and characteristics of a blockage or blockages in a practical and cost-effective manner would therefore be beneficial.

What is needed for detecting full and partial blockage conditions in an enclosed environment, such as a pipeline, is a method and associated systems that can identify in real-time the onset of blockages of varying compositions in a region or regions of that environment. What is also needed is a response time for blockage detection that permits the appropriate steps to be taken to correct a potential blockage situation before the blockage or blockages fully develop and thereby reduce or eliminate flow in an enclosed environment. What is also needed is an economical and practical means to detect blockages over substantial portions of an enclosed environment from a remote position. As such, what is also needed is a way to detect blockages relatively far from the immediate vicinity of the enclosed environment.

### SUMMARY OF THE INVENTION

The invention provides a method of detecting the presence or absence of a blockage in an enclosed environment. The method includes introducing an acoustic wave into the enclosed environment; receiving at sensor locations the acoustic wave and any reflected acoustic wave caused by the acoustic wave contacting a blockage; and, analyzing the acoustic wave and any reflected acoustic wave to determine the presence or absence of the blockage. The method can also include coherently accumulating into a digitized data array an electrical response indicative of the received acoustic wave and any reflected acoustic wave caused by the blockage. The method can further include computing a correlation between the introduced acoustic wave and the digitized data array.

The invention also provides a system for detecting the presence or absence of a blockage in an enclosed environment that embodies the method of the invention. The system can include a communications interface for remote analysis and/or control of the system by a user.

In another aspect, the invention is embodied in a computer-readable medium containing instructions for controlling a computer to perform detection and analysis on blockages in an enclosed environment. The instructions comprise constructing an interrogation waveform at a predetermined sampling rate; directing a transmitter to introduce the interrogation acoustic wave into the enclosed environment; coherently accumulating an electrical response into a digitized array representative of the interrogation acoustic waves and any acoustic wave reflected from a blockage; and, computing a correlation between the interrogation acoustic wave and the digitized data array.

### BRIEF DESCRIPTION OF THE DRAWINGS

A full understanding of the invention can be gained from the following detailed description of the invention when read in conjunction with the accompanying drawings in which:

FIG. 1 is a system diagram of an embodiment of the invention;

FIG. 2 is a process flow diagram of a computer-implemented method embodiment of the invention;

FIG. 3 is a process flow diagram providing further detail of a portion of FIG. 2;

FIG. 4 is a plot of graphical results provided by an example of the invention;

FIG. 5 is a plot of graphical results provided by an example of the invention;

FIG. 6 is a plot of graphical results provided by an example of the invention; and,

FIG. 7 is a plot of graphical results provided by an example of the invention.

### DETAILED DESCRIPTION OF THE PREFERRED EMBODIMENTS

As used herein, the term “blockage” can be used to indicate any solid, gas, liquid, or possible combination thereof which reduces, restricts, or otherwise interferes with normal movement of the contents of an enclosed environment.

The term “enclosed environment” is used herein to indicate a containment of a gas, fluid and/or liquid and/or inter-phases thereof and can include, for example and without limitation, a pipeline, a tank or a portion thereof.

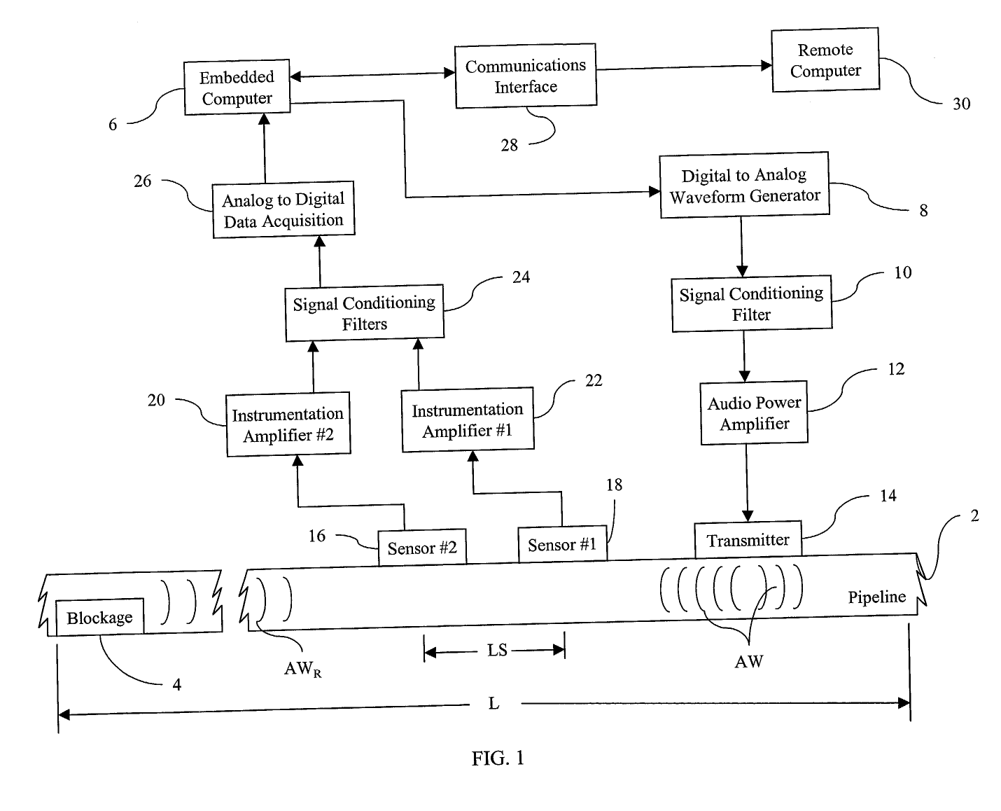

Referring now to FIG. 1, a portion of an enclosed environment, such as a length L of gas pipeline 2 in the invention as shown, can be selected for blockage detection and analysis. It is understood that the portion is selected based on a variety of detection and analysis objectives. For example, if a particular section of the enclosed environment is especially critical to production, then the invention can be applied as a proactive measure to analyze the enclosed environment periodically in anticipation of potential blockages within that section. This is a preventative application of the invention to identify blockages during their formative stages and to provide response time to undertake corrective action to halt maturity of the blockages into complete or substantially complete blockages within the enclosed environment. In one illustrative situation, if the measured output of a particular section of an enclosed environment is not within normal tolerance ranges, then the normal flow rate can be reduced substantially. The invention can therefore be applied to verify the existence and characteristics of one or more potential blockages, so that corrective action can be taken. The blockage 4 in the enclosed environment of the pipeline 2 can be composed of any material, including liquid, solid, gas, and/or inter-phases thereof and can be either a single-phase blockage or any combination of these phases.

Referring again to FIG. 1, a system embodiment of the invention is shown. As mentioned above, in this embodiment the enclosed environment is the gas pipeline 2. A blockage 4 is present in the pipeline. An embedded computer 6, which can be any conventional microprocessor or microprocessor suitable for use with the functions performed by the invention, controls a conventional digital to analog waveform generator 8. The waveform provided by the waveform generator 8 is processed through a signal conditioning filter 10. The signal conditioning filter 10 can be a conventional filter circuit such as a first order low-pass Butterworth filter with a cutoff frequency of approximately 128 Hz. The filtered signal is then processed through a standard audio power amplifier 12 that amplifies the signal to the extent necessary for the signal's introduction to a transmitter 14.

Referring again to FIG. 1, the transmitter 14 produces acoustic waves AW which can be introduced at any point along the pipeline 2. The transmitter 14 transforms the electrical interrogation signal ultimately received from the waveform generator 8 into these acoustic waves AW. The transmitter 14 can be a standard subwoofer, loudspeaker or any other suitable transmitting method or apparatus such as a diaphragm driven by a linear method. The acoustic waves AW can be any desired frequency, and can be audible or inaudible within the range of typical human hearing. However, it can be appreciated that the frequency of the acoustic waves AW must be sufficiently low to survive the attenuation caused by travel of the interrogation signal traveling from the transmitter 14 to the blockage 4 and back to the sensors 16 and 18. In a preferred embodiment of the invention, the frequency fAW of the acoustic waves AW is preferably in the range of about 10 to 80 Hz. Other parameters for the acoustic waves AW, such as amplification, bandpass range, sampling rate and the like can be determined and input to the system in connection with selection of a desired frequency fAW.

Referring again to FIG. 1, the acoustic waves AW travel along both directions of the pipeline 2 and, upon encountering the blockage 4, reflected acoustic waves AWR are produced. One or more of the acoustic waves AW and the reflected acoustic waves AWR can be detected and received by a pair of sensors 16, 18, which can be embodied as standard pressure transducers such as, for example, those ceramic transducers sold under the “PZT-4” trade designation or their like. In general, it can be appreciated that the elapsed time between the acoustic waves AW and the reflected acoustic waves AWR passing the sensors 16, 18 at a given point determines the location of the blockage 4 in the portion L of the pipeline to be reviewed for corrective action. In one aspect of the invention, the portion L is a length of pipeline that is preferably in the range of a fraction of a mile to hundreds of miles.

Referring again to FIG. 1, the sensors 16, 18 can be positioned a sensor distance LS that is approximately a quarter of a wavelength of the acoustic waveform AW to indicate the direction of propagation of the acoustic waves AW and/or the reflected acoustic waves AWR and then aid in determining a location for the blockage 4. Pressure readings from the sensors can then be processed through one or more amplifiers 20, 22 as shown. The amplifiers 20, 22 can be standard amplifier configurations and preferably provide a gain of 40 dB to the signal received from the sensors 16, 18. One or more signal conditioning filters 24 can then be employed to filter the signal received from each of the sensors 16, 18. The signal conditioning filters 24 can be a third order low-pass Butterworth filter that has a circuit configuration with an approximately 128 Hz cut-off frequency. An analog to digital conversion apparatus 26 can then be employed to digitize the processed sensor signals into a digitized data array. This digital data, indicative of the nature of the blockage 4 in the pipeline 2, can be processed through the embedded computer 6. The data array is analyzed by the computer-implemented method of the invention (discussed hereinafter).

Referring again to FIG. 1, it can be appreciated that control of the embedded computer 6 can be conducted over a communications interface 28 with a remote computer 30.

Processing and analysis of blockage data can be performed on one or both of the embedded computer 6 and the remote computer 30. The communications interface 28 can be a wireless or direct connection between the computers 6, 30. The communications interface 28 can also be embodied as an Internet site, or other suitable networked connection, that permits a user to access, monitor and/or control the embedded computer 6. The communication link can also be a telephone or wireless connection, or other field bus as commonly used in supervisory control systems. This arrangement permits real-time access to acquired and analyzed blockage data.

The method of the present invention also includes acquiring electrical responses from the sensors and converting these electrical responses into a digital data array having elements that are representative of the acoustic waves and the reflected acoustic waves. These data representations provide an indication of the characteristics of the blockage in the enclosed environment. The method also includes analyzing the data array with a method implemented by the embedded computer and/or the remote computer to identify the characteristics of the blockage or blockages in the enclosed environment. The computer-implemented method discussed hereinafter is used for acquiring, storing and analyzing these data representations to determine the characteristics of any blockages detected in the enclosed environment.

A computer-implemented method of analyzing data related to detection and analysis of blockages in an enclosed environment is also provided by the invention. As previously discussed, the method is designed for use with a system that employs acoustic waveforms introduced into an enclosed environment, such as a pipeline. Reflected acoustic waves are reflected from any blockage or blockages detected within the enclosed environment. Sensors provide a signal that is converted into a digital data array indicative of the reflected acoustic waves. This digital data is then analyzed by the method of the invention.

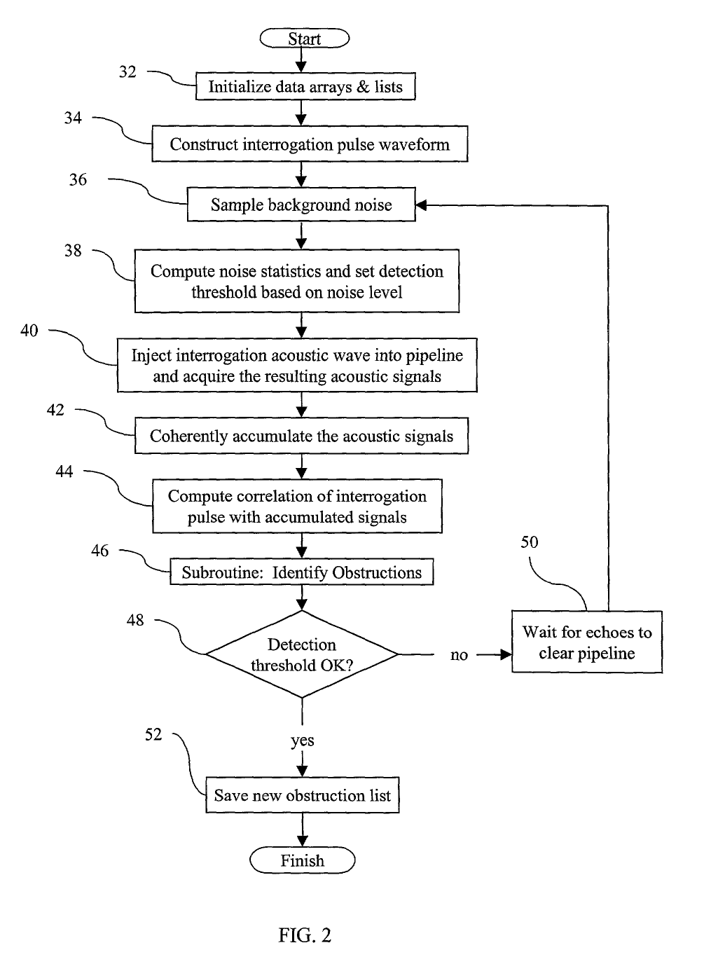

Referring now to FIG. 2, the method of the present invention includes initializing the data arrays and lists in step 32. This step 32 includes initializing an empty data set for acquisition of new data and preparing previously acquired and stored blockage characteristics for comparison to newly acquired data arrays. In one aspect of the invention, for all data arrays that contain the sampled points representative of the reflected acoustic signals, the array length is set for the number of samples obtained in the time that the interrogation acoustic waves travel the length of the pipe. This step 32 also includes initializing to zero all arrays that contain accumulated values, setting array lengths and setting to zero the accumulated values for those arrays used in sampling background noise level. This step 32 further includes clearing the list of obstructions so that it is initially empty.

Referring again to FIG. 2, in step 34 of the invention as shown, the method also includes constructing an interrogation pulse waveform as a set of sample points at a given sampling rate. The interrogation pulse can comprise any finite length waveform but is often taken to be a few cycles of a low-frequency sinusoidal wave having its amplitude modulated by a standard Hanning window function. In step 36, the method includes sampling background noise of the enclosed environment to detect interference or other acoustic disturbance that could mask the reflected signal. This step 36 includes taking samples of the acoustic signal, with no interrogation pulse in the pipe, to determine the background noise level. Samples are typically taken before each interrogation acoustic wave is introduced into the enclosed environment.

Referring again to FIG. 2, in step 38 of the invention as shown, noise statistics are computed and a detection threshold is set based on the noise level in the enclosed environment. This step 38 can also include combining the current samples of the background noise signals to compute the noise statistics, and using the statistics to compute the threshold for echo detection. It can be appreciated that a standard Neyman-Pearson technique for substantially constant false alarm rate can be used to set this threshold. Alternatively, a number of other techniques can be used to set the threshold, examples of which may be found in Fundamentals of Statistical Signal Processing, Volume II, Detection Theory by Steven M. Kay, published by Prentice Hall PTR, 1998. A blockage will therefore be detected if the correlation computed in step 44 exceeds the threshold. For example, if the background noise has white Gaussian statistics with mean equal to zero, the samples, after computing the correlation as in step 44, will have a Rayleigh probability distribution,

$$f ( x ) = \frac{x}{{a}^{2}} exp ( - \frac{{x}^{2}}{2 {a}^{2}} ) ,$$

where α=μ\sqrt{2/π} and μ is the mean of the distribution. The mean can be determined using standard sampling techniques, and the desired threshold, T, is calculated using the equation

$$T = 2 μ \sqrt{\frac{1}{π} ln ( 1 / {P}_{FA} )} ,$$

where P_{FA} is the desired false alarm rate according to the Neyman-Pearson criterion. If, for example, a false alarm rate of 0.001 is desired, the resulting threshold is 2.966 times the mean noise value after correlation processing. In step 40, the method includes directing the transmitter, as previously discussed, to introduce the interrogation acoustic wave into the enclosed environment and acquire the acoustic wave and reflected acoustic waves with the sensors. This step 40 includes introducing the interrogation pulse into the pipe and acquiring sample points of the reflected acoustic waves at each sensor at the given sampling rate. The number of sample points acquired is determined by the time required for the interrogation pulse to travel to the end of the enclosed environment and return to the sensors.

Referring again to FIG. 2, in the form of the invention shown, the electrical response of the sensors is coherently accumulated in step 42 into a digitized array that is representative of interrogation acoustic waves and reflected acoustic waves. For each sensor, the method includes coherently accumulating the acquired acoustic signals at that sensor by adding each sample point of the current acoustic signal to the corresponding point of the accumulator array.

In step 44, the method includes computing correlation between the introduced interrogation acoustic wave and the digitized data array. This identifies the change between signal characteristics that determines the effect of the blockage or blockages in the enclosed environment on the reflected interrogation signal. This also provides an indirect indication of the physical characteristics such as the severity and location of the blockage or blockages. For each sensor, the method includes computing the discrete-time correlation function of the interrogation pulse waveform with the accumulated acoustic signal for that sensor. For each sensor, the method also includes (as an alternative to computing the discrete-time correlation function) processing the accumulated acoustic signal for that sensor by a matched digital filter, which is matched to the interrogation acoustic waveform.

The correlation function is best described by the equation

$$C ( n ) = {( {( {\sum }_{k = 0}^{{N}_{i} - 1} S ( n + k ) p ( k ) )}^{2} + {( {\sum }_{k = 0}^{{N}_{i} - 1} S ( n + k ) q ( k ) )}^{2} )}^{1 / 2} ,$$

where C(n) equals the correlation between the interrogation signal and the received signal, S(n+k) equals the magnitude of the acoustic signal received at time n+k, p(k) for k=0, 1, . . . N_{I}−1 is the waveform of the interrogation pulse, q(k) is the quadrature representation of the interrogation pulse waveform, N₁ equals the number of points in the interrogation pulse, and n=0, 1, . . . , N−Nᵢ where N equals the number of points in the received acoustic signal.

Referring again to FIG. 2, in step 46 of the invention shown and described hereinafter in further detail, characteristics of the blockage or blockages are identified and can be stored for future reference and use. The method then makes a check in step 48 to determine whether the detection threshold is sufficiently sensitive to detect the desired level of blockages. If the detection threshold is not sufficiently sensitive, as when there is excessive noise affecting the enclosed environment, then the method, after waiting for echoes from the interrogation acoustic wave pulse to clear the enclosed environment, returns to step 36 to average in one or more additional samples and thereby improve the signal to noise ratio. If the detection threshold is found satisfactory in step 48, then the obstructions which have been detected at that point are saved as a new list of obstructions in step 52. Otherwise, in step 50, the method waits for undesirable echoes in the enclosed environment to clear and the method resumes processing at step 36.

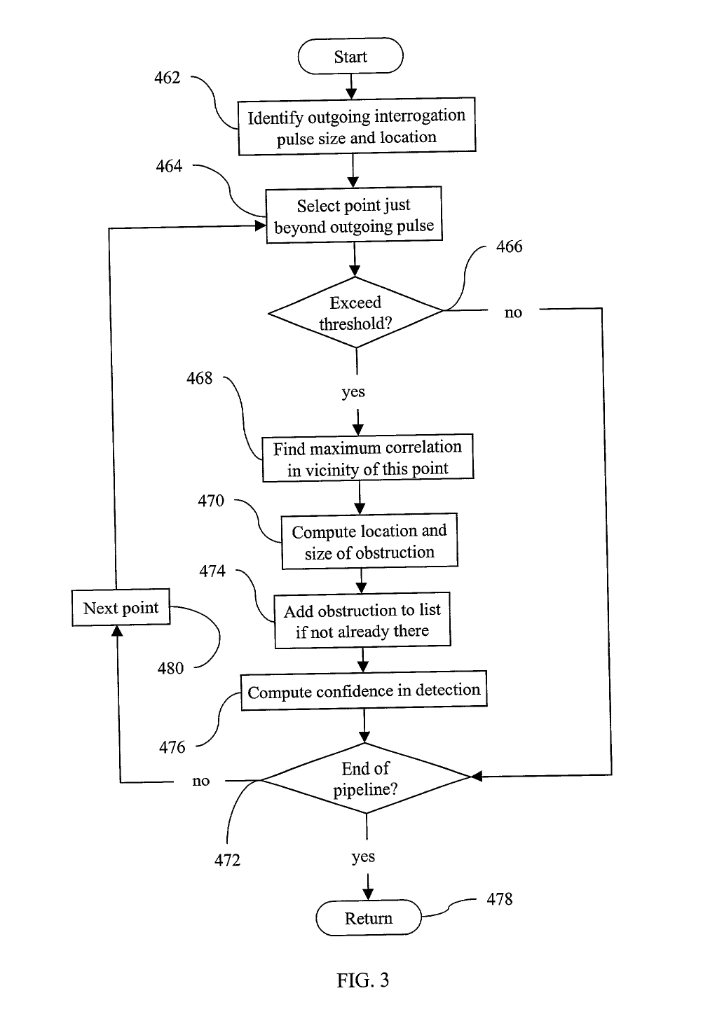

Referring now to FIGS. 2 and 3, the function of the subroutine shown in step 46 of FIG. 2 is described in further detail. This subroutine includes identifying the outgoing interrogation pulse in the correlation function to determine its size and location in step 462. In step 462, the method includes identifying the size and location of the outgoing interrogation pulse at each sensor by finding the peak value of the correlation function in the region at the beginning of the signal, or where the pulse is expected to be. The size of the peak serves as a reference for each sensor for determining the relative strength of a wave reflected from an obstruction. In addition, the location of the peak provides a reference to determine the round trip travel time of the reflected wave, which in turn identifies the location of the obstruction.

Referring now to FIG. 3, in the form of the invention shown, a further subroutine is established that includes examination of each point of the correlation function starting just beyond the outgoing pulse in step 464. In step 464, the method includes selecting a location that is just beyond the outgoing acoustic waves. This point becomes a first point to be examined for a possible reflected acoustic wave generated by an obstruction.

In step 466, the method provides for determining whether that point of the correlation function exceeds the predetermined threshold. If the correlation function of one or both sensors exceeds the threshold at the current point, then the method provides for examining this point further in step 468. Otherwise, if the threshold is not exceeded, then the method proceeds in step 472 with determining whether the end of the correlation function, which corresponds to the end of the enclosed environment to be analyzed, has been reached.

If, however, the threshold is exceeded and a blockage is detected, the method provides in step 468 for finding the local maximum of the correlation function. If the correlation function of either sensor is a maximum over all points which are within the length of the interrogation pulse from the current point, then a reflected wave is detected and the method proceeds with step 470. Otherwise, this point is rejected and the method proceeds to step 472.

In step 470 of the invention, the method includes computing the size of the blockage and its location within the enclosed environment. It can be appreciated that in FIG. 1 blockage 4 can be to the right of the transmitter 14, and in this case the reflected wave AWR propagates from right to left. The propagation direction of the echo and the time that the echo is received determine the location of the blockage. This step 470 also resolves the echo into possible left-to right and/or right-to-left propagating pulses by computing the optimal position and size of each of the two possibilities which best fit with the signals received at each sensor. Determining the direction of propagation of the returning acoustic signal is calculated by comparing the correlations corresponding to travel in each direction. Therefore, where C₁ is the correlation coefficient for leftward propagation, and Cᵣ is the correlation coefficient for rightward propagation, C₁>Cᵣ indicates a leftward propagating return signal, and Cᵣ>C₁ indicates a rightward propagating return signal. C₁ is calculated according to the equation C₁=Σ(S₁ (n)Sᵣ (n −d/c)), where S₁ (n) equals the signal magnitude at the left sensor at time n, d is the distance between the sensors, c is the speed of sound in the medium within the pipe, and Sr(n) is the signal magnitude at the right sensor at time n. Likewise, Cᵣ=Σ (S₁ (n−d/c)Sᵣ (n)). A conventional least-squares method can be used to compute the sufficiency of this fit. The sensors are preferably positioned approximately a quarter wavelength apart so that the direction of propagation can be resolved. The method then includes computing the location of the corresponding obstruction based on the speed of sound and the flow of the medium inside the pipe and on the propagation direction of the reflected acoustic wave. In step 474, the blockage characteristics, which can include the size of the blockage and its position within the enclosed environment, for example, can be stored in a suitable storage medium for later use. In step 474, if the amplitude of either the acoustic wave or a reflected acoustic wave exceeds the detection threshold, it can be added to the list of obstructions. This list of obstructions also permits the invention to identify erroneous detection of blockages that may have resulted from secondary reflections of acoustic waves from other obstructions.

The confidence in the detection of a blockage is then computed in step 476. This confidence computation is based on the strength of the return pulse and the background noise level. The method next proceeds from step 476 to step 472 to determine whether the system has analyzed the entire, desired portion of the enclosed environment. If the entire portion has been analyzed, then the method returns in step 478 to continue processing after step 46 shown in FIG. 2. If more of the portion of the enclosed environment remains to be analyzed, then the method goes to step 480 to perform calculations for another point of the correlation function.

In the subroutine shown in step 46 of FIG. 2 and in all of FIG. 3, an alternative implementation is to replace the correlation function by a filtered signal, which is obtained by processing the accumulated acoustic signal by a matched digital filter, which is matched to the interrogation acoustic waveform.

The following examples are intended to be illustrations of certain aspects of the invention herein disclosed. These examples are intended for illustration purposes only and are not intended to limit the scope of the invention.

### EXAMPLE 1

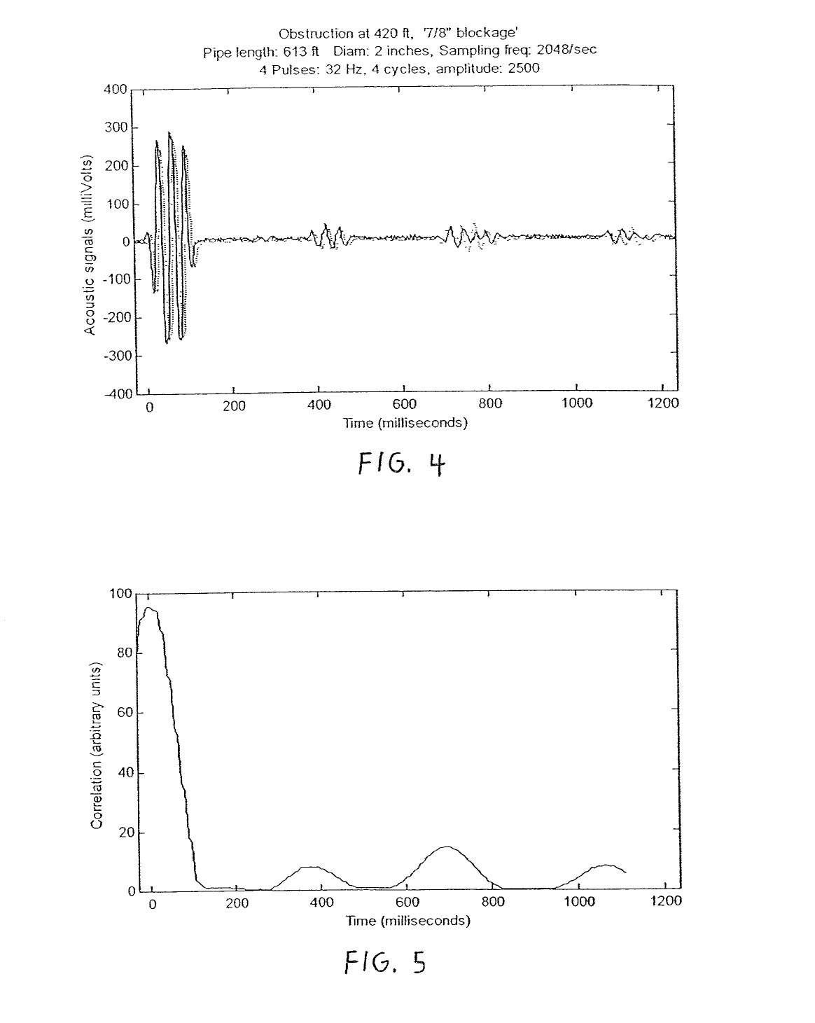

Referring now to FIGS. 4 and 5, acoustic waves are transmitted through an enclosed environment provided as a pipeline having a length of 187 meters from sensor #1 and a diameter of 2 inches. Sensor #1 is 0.61 meters (2 feet) from the transmitter, and the distance between sensors employed in this embodiment of the invention is 2.67 meters (8.75 feet). The sampling frequency is 2048 per second and the acoustic waves include 4 pulses having a frequency of 32 Hz with 4 cycles and an amplitude of 2500 millivolts.

Referring now to FIG. 4, it can be seen that an acoustic signal is generated approximately at the marked intervals of 375, 695 and 1070 msec. on the horizontal axis. Referring then to FIG. 5, a correlation is provided in the peaks of FIG. 5 with the marked intervals in FIG. 4. The amplitude of each peak is therefore a function of the correlation provided by a reflected wave generated by the type and nature of a blockage or other obstruction that has been detected.

In FIGS. 4-5, the acoustic signal and corresponding correlation peak at 0 msec. are due to the outgoing acoustic wave. Those at 695 msec. are due to the reflected acoustic wave from a partial blockage 4 of size 0.875 inch at a distance of 420 feet (128 meters) from sensor 18. Those 1070 msec. are due to the acoustic wave reflected from the end of the pipe 2, which is 613 feet (187 meters) from sensor 18. Those at 375 msec. are due to an acoustic wave which is reflected from the beginning of the pipe 2, which is to the right of the transmitter 14 as it appears in FIG. 1. The direction that this acoustic wave is travelling is readily apparent in that it is seen at sensor 18 before sensor 16.

The mean background noise was determined by sampling to be 0.9363, and, according to the Neyman-Pearson criterion for white Gaussian noise, a threshold of 2.966×0.9363=2.777 results in a false alarm rate of 0.001.

When each returning acoustic signal is received by the sensors 16 and 18, the correlation with the interrogation signal is first calculated according to the above-described equation

$$C ( n ) = {( {( {\sum }_{k = 0}^{{N}_{i} - 1} S ( n + k ) p ( k ) )}^{2} + {( {\sum }_{k = 0}^{{N}_{i} - 1} S ( n + k ) q ( k ) )}^{2} )}^{1 / 2} .$$

The correlation therefore equals C(n)=14.4. A correlation of 14.4 as calculated indicates that the received signal is well above the detection threshold and is in fact a reflected interrogation signal. Multiplying the time elapsed between the interrogation pulse and the received pulse by the speed of sound in the medium within the pipe results in the distance between the sensors and the obstacle, keeping in mind that this distance must then be divided in half because the sound has traveled both to the obstacle and back. Therefore, (rate×time)÷2=(368×0.695 seconds)/2=128 meters. To determine if the received acoustic wave is traveling leftward or rightward, first calculate C₁ equals −46934, next calculate Cᵣ equals 36056, and then compare to determine which is greater. In this case, Cᵣ is greater, indicating a rightward propagating wave, thereby indicating a blockage located to the left of the sensors. The size of the blockage is calculated by multiplying the magnitude of the correlation by a calibration constant for the device.

### EXAMPLE 2

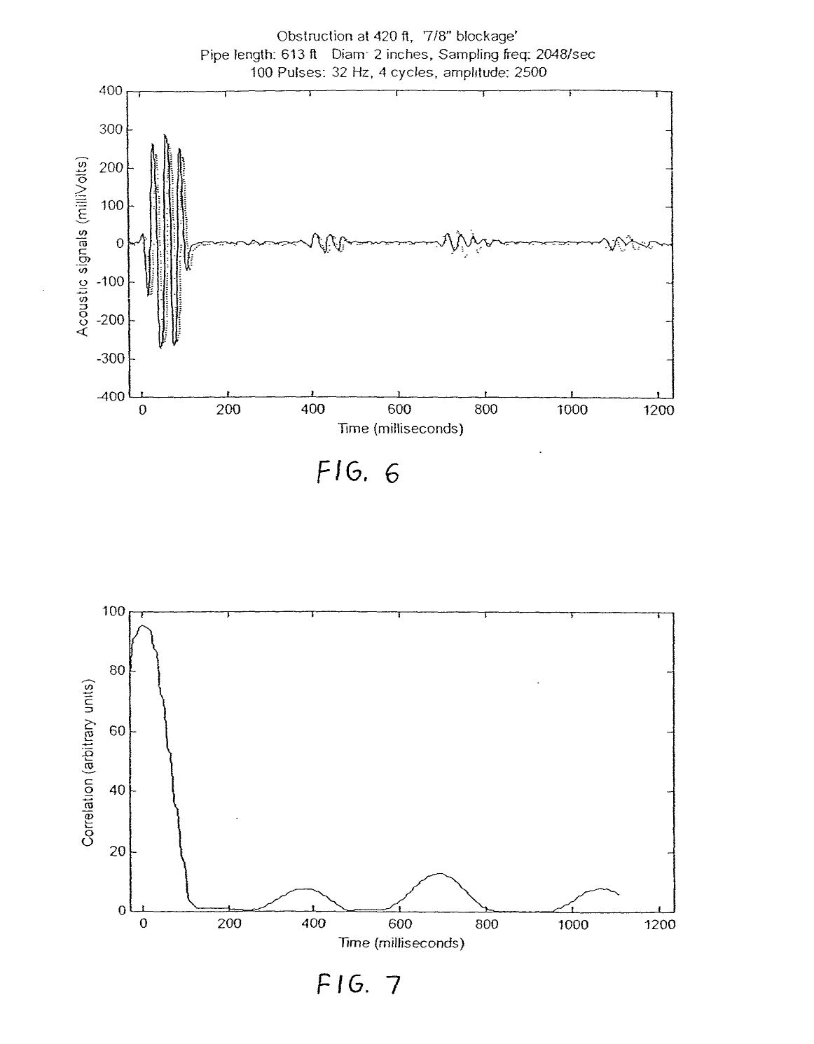

Changing the number of pulses from 4 in the above example to 100 here, and referring now to FIGS. 6 and 7, acoustic waves are transmitted through an enclosed environment provided as a pipeline having a length of 187 meters from sensor #1 and a diameter of 2 inches. The distance between sensors employed in this embodiment of the invention is 2.67 meters. The sampling frequency is 2048 per second and the acoustic waves include 100 pulses having a frequency of 32 Hz with 4 cycles and an amplitude of 2500.

Referring now to FIG. 6, it can be seen that an acoustic signal is generated approximately at the marked intervals of 378, 693 and 1070 along the horizontal axis. Referring then to FIG. 7, a correlation is provided in the peaks of FIG. 7 with the marked intervals in FIG. 6. The amplitude of each peak is therefore a function of the correlation provided by a reflected wave generated by the type and nature of a blockage or other obstruction that has been detected.

The calculation in Example 1 is performed in a similar manner here, with the only difference being that the signal and noise are averaged over 100 pulses instead of 4. The background noise is reduced to 0.64, and the resulting threshold is 1.898, thus improving the signal to noise ratio. The correlation is again equal to

$$C ( n ) = {( {( {\sum }_{k = 0}^{99} S ( n + k ) p ( k ) )}^{2} + {( {\sum }_{k = 0}^{99} S ( n + k ) q ( k ) )}^{2} )}^{1 / 2} = 12.8 .$$

Once it is determined that the received signal is in fact a returned interrogation pulse, the distance the obstacle can be calculated by (rate times time)÷2=(368×0.693)÷2=128 meters. Also as before, C₁=−44217, Cᵣ=36262. Again, Cᵣ is greater than C₁, indicating a rightward propagating soundwave, indicating a leftward obstacle.

Therefore, it can be appreciated that the method and system of the invention provide the benefit of remote sensing and analysis in a far-field environment. This is distinct from traditional acoustic sensing applications, which are designed for open environments such as sonar applications, for example, or near-field applications such as medical sonogram applications. The remote detection system and methods of the present invention have applications that include, and are not limited to, providing real-time information on the state of the blockage in the enclosed environment; identifying breaches in the enclosed environment, identifying and characterizing phase transformations within the enclosed environment; testing and analyzing the acoustical and other related physical properties of the enclosed environment; and, identifying the mechanical structures or other equipment employed within the enclosed environment.

While specific embodiments of the invention have been described in detail, it can be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the appended claims and any and all equivalents thereof.

What is claimed is:

1. A method of detecting the presence or absence of a blockage in an enclosed environment, comprising:
a. introducing into said enclosed environment an acoustic wave;
b. receiving at sensor locations of said enclosed environment said acoustic wave and any reflected acoustic wave caused by a said blockage; and,
c. analyzing said acoustic wave and any said reflected acoustic wave from said sensor locations to determine the presence or absence of any said blockage in said enclosed environment.

2. The method of claim 1, including coherently accumulating into a digitized data array an electrical response indicative of said received acoustic wave and any reflected acoustic wave caused by said blockage from both of said two sensor locations.

3. The method of claim 2, further including computing a correlation between said introduced acoustic wave and said digitized data array and detecting the propagation direction using a cross-correlation between (i) said acoustic wave and said reflected acoustic wave received at a first said sensor location and (ii) said acoustic wave and said reflected acoustic wave received at a second said sensor location.

4. The method of claim 3, further including outputting a graphical representation indicative of said correlation.

5. The method of claim 3, further including storing a numerical representation indicative of said correlation.

6. The method of claim 1, wherein said enclosed environment is a length of gas pipeline.

7. The method of claim 1, wherein said introducing step includes using a transmitter for producing acoustic waves having a frequency in the range of about 10 to 80 Hz.

8. The method of claim 1, further including separating said sensor locations by a distance equivalent to approximately a quarter of a wavelength of said acoustic wave.

9. A system for detecting the presence or absence of a blockage in an enclosed environment, comprising:
a. means for introducing into said enclosed environment an acoustic wave;
b. means for receiving from locations of said enclosed environment said acoustic wave and any reflected acoustic wave caused by a said blockage; and,
c. means for analyzing said acoustic wave and any said reflected acoustic wave received from said locations to determine the presence or absence of any said blockage in said enclosed environment.

10. The system of claim 9, further comprising a communications interface connected to said system.

11. The system of claim 10, wherein said communications interface is selected from the group consisting of wireless, direct connection and network connection.

12. The system of claim 9, further comprising means for controlling said detection system from a remote distance.

13. A computer-readable medium containing instructions for controlling a computer to perform detection and analysis on blockages in an enclosed environment, said instructions comprising:
a. constructing an interrogation waveform at a predetermined sampling rate;
b. directing a transmitter to introduce said interrogation waveform into said enclosed environment;
c. coherently accumulating an electrical response into a digitized array that is representative of said interrogation waveform and any waveform reflected from a said blockage; and,
d. computing a correlation between said interrogation waveform and said digitized data array.

14. The medium of claim 13, further comprising instructions for sampling background noise of said enclosed environment to detect interference or other acoustic disturbance and determine a noise level for said enclosed environment.

15. The medium of claim 14, further comprising instructions for computing a detection threshold based on said noise level in said enclosed environment.

16. The medium of claim 13, further comprising instructions for identifying characteristics of said blockage.

17. The medium of claim 13, further comprising instructions for outputting a graphical representation indicative of said correlation.

18. The medium of claim 13, further comprising instructions for storing a numerical representation indicative of said correlation.
